(19) United States
(12) Patent Application Publication
(10) Pub. No.: US 2023/0168629 A1
(43) Pub. Date: Jun. 1, 2023

(54) BALANCE-SPRING FOR TIMEPIECE RESONATOR MECHANISM PROVIDED WITH MEANS FOR ADJUSTING THE STIFFNESS

(71) Applicant: OMEGA SA, Biel/Bienne (CH)

(72) Inventors: Ivan HERNANDEZ, Cressier (CH); Roberto Frosio, Chambrelien (CH)

(73) Assignee: OMEGA SA, Biel/Bienne (CH)

(21) Appl. No.: 18/070,111

(22) Filed: Nov. 28, 2022

(30) Foreign Application Priority Data
Nov. 29, 2021 (EP) 21211101.7

(51) Int. Cl. G04B 18/04; G04B 18/08

(52) U.S. Cl. CPC G04B 18/04; G04B 18/08

(57) ABSTRACT

A balance-spring, particularly for a timepiece resonator mechanism. An adjustment device include a single elongated flexible element (5) arranged in series of strip (2), connecting one end (4, 9) of said strip (2) to a fixed support (11), to add an additional stiffness to the strip (2), and having a stiffness greater than that of the strip (2). A prestressing means (6) applies at least two different stresses on the elongated flexible element (5), the first stress being provided by a tensile/compressive force directed substantially in the longitudinal direction F_{L} of the elongated flexible element (5), and the second stress being provided, either by a force directed substantially in a direction substantially orthogonal F_{T} to the longitudinal direction of the elongated flexible element (5), or by a torque M, preferably a bending moment, in such a way as to vary the stiffness of the elongated flexible element (5).

### CROSS REFERENCE TO RELATED APPLICATIONS

This application claims priority to European Patent Application No. 21211101.7 filed Nov. 29, 2021, the entire contents of which are incorporated herein by reference.

### TECHNICAL FIELD OF THE INVENTION

The invention relates to a balance-spring for a timepiece resonator mechanism, the balance-spring being provided with means for adjusting the stiffness of said balance-spring. The invention also relates to a timepiece resonator mechanism provided with such a balance-spring.

### TECHNOLOGICAL BACKGROUND

Most present-day mechanical watches are equipped with a sprung balance and with a Swiss lever escapement. The sprung balance constitutes the time base of the watch. It is also referred to as the resonator.

The escapement, for its part, fulfils two key functions:
sustaining the to-and-fro motions of the resonator;
counting these to-and-fro motions.

To constitute a mechanical resonator, an inertial element, a guide and an elastic return element are needed. Traditionally, a balance-spring plays the role of elastic return element for the inertial element that constitutes a balance. This balance is rotationally guided by pivots that rotate in smooth ruby bearings.

The balance-spring must generally be able to be adjusted to improve the precision of a watch. For this purpose, means for adjusting the stiffness of the balance-spring are used, such as an index for modifying the effective length of the spring. Thus, its stiffness is modified to adjust the rate precision of the watch. Nevertheless, the effectiveness of a traditional index to adjust the rate remains limited, and it is not always effective for making the adjustment sufficiently precise, in the order of a few seconds or a few tens of seconds per day.

For a more precise adjustment of the rate, adjustment means exist comprising one or more screws, arranged in the felloe of the balance. By acting on the screws, the inertia of the balance is modified, which has the effect of modifying its rate.

However, this adjustment mode is not easy to perform, and even so does not make it possible to obtain a sufficient precision of the adjustment of the rate of the oscillator.

### SUMMARY OF THE INVENTION

The aim of the present invention is to overcome all or part of the aforementioned drawbacks, by proposing a balance-spring provided with effective and accurate adjustment means, configured in particular to adjust the rate of a timepiece by modifying the effective stiffness of said balance-spring.

To this end, the invention relates to a balance-spring, particularly for a timepiece resonator mechanism, the balance-spring comprising a flexible strip coiled around itself according to a plurality of coils, the strip having a predefined stiffness, the balance-spring including means for adjusting its stiffness.

The invention is remarkable in that the adjustment means include a single elongated flexible element arranged in series of the strip, the elongated flexible element connecting one end of said strip to a fixed support, in such a way as to add additional stiffness to the strip, the adjustment means including prestressing means to apply at least two different stresses on the elongated flexible element, the first stress being provided by a tensile/compressive force directed substantially in the longitudinal direction of the elongated flexible element, and the second stress being provided, either by a force directed in a direction substantially orthogonal to the longitudinal direction of the elongated flexible element, or by a torque, preferably a bending moment, in such a way as to vary the stiffness of the elongated flexible element depending on the prestressing level.

Thanks to the invention, it is possible to modify the stiffness of the elongated flexible element, such as a flexible blade. Indeed, when two stresses such as those aforementioned are applied, it is possible to vary the stiffness of the elongated flexible element. Indeed, with a single applied stress, whether that is a force or a torque, the stiffness of the elongated flexible element remains the same. With two perpendicular forces on the blade, longitudinally and orthogonally, an overall force is obtained, which varies the stiffness of the elongated flexible element. With a force and a torque, the stiffness is also modified. The combination of two stresses being vital to achieve this.

By acting on the prestressing means, the level of intensity of the load is modulated, which results in a modification of the stiffness of the assembly comprising the flexible element and the strip. Indeed, the flexible element placed in series with the strip provides an additional stiffness, which combines with that of the strip. Thus, when the prestressing means apply variable stresses on the flexible element, they modify the stiffness of the flexible element and therefore of the assembly comprising the strip and the flexible element without modifying the stiffness of the strip, regardless of the variable forces applied on the elongated flexible element.

In other words, a flexible element is placed in series of the strip between one end of the strip and the fixed support. This flexible element modifies the stiffness of the attachment point and provides an additional flexibility to the resonator. Thus, the effective stiffness of the resonator comprises the stiffness of the strip and the stiffness of the flexible element. The variable stresses are then applied to prestress the flexible element without prestressing the strip. By prestressing the flexible element, its stiffness changes, whereas the stiffness of the strip remains substantially unchanged. By changing the stiffness of the flexible element, the stiffness of the resonator (stiffness of the strip and stiffness of the flexible element) changes, which consequently modifies the rate of the resonator.

Consequently, a modification of the stiffness of the flexible element modifies the stiffness of the assembly of the resonator, and consequently finely adjusts its rate, which makes it possible to precisely adjust the frequency of our time base. Thus, high precision is obtained in the adjustment of the rate, because only one element is acted on to adjust the stiffness.

According to a particular embodiment of the invention, the prestressing means are configured to exert a third stress on the elongated flexible element, the third stress being provided, respectively to the second stress, or by a force directed substantially in a direction substantially orthogonal to the longitudinal direction of the elongated flexible element, or by a torque, preferably a bending moment.

According to a particular embodiment of the invention, the longitudinal flexible element is a single flexible blade.

According to a particular embodiment of the invention, the flexible element is arranged in a radial direction of the balance-spring.

According to a particular embodiment of the invention, the flexible element is arranged in a direction tangential to the balance-spring.

According to a particular embodiment of the invention, the prestressing means include a lever joined to the end of the strip.

According to a particular embodiment of the invention, the lever is flexible.

According to a particular embodiment of the invention, the lever is curved and surrounds at least partially the coiled strip.

According to a particular embodiment of the invention, the lever comprises a free end that can be actuated by a movement of said free end in order to apply said stresses on the end.

According to a particular embodiment of the invention, the prestressing means include two means for applying a force, each means for applying a force being provided with a spring connected to the end, to apply said longitudinal force or said orthogonal force on the end.

According to a particular embodiment of the invention, the end of the strip comprises an attachment, the prestressing means and the elongated flexible element being joined to the attachment.

According to a particular embodiment of the invention, the longitudinal and orthogonal forces, and optionally the torque, can be continuously adjusted by the prestressing means.

According to a particular embodiment of the invention, the flexible element is arranged at an outer end of the strip.

According to a particular embodiment of the invention, the end of the strip is stiffer than the elongated flexible element and the strip.

According to a particular embodiment of the invention, the elongated flexible element is arranged at an outer end of the strip.

According to a particular embodiment of the invention, the elongated flexible element comprises a flexible neck.

The invention also relates to a rotary resonator mechanism, particularly for a horological movement, including an oscillating mass and such a balance-spring.

### BRIEF DESCRIPTION OF THE FIGURES

The aims, advantages and features of the present invention will become apparent upon reading a plurality of embodiments given only by way of non-limiting examples, with reference to the appended drawings wherein:

FIG. 1 schematically shows a top view of a balance-spring according to a first embodiment of the invention,

FIG. 2 schematically shows a top view of a balance-spring according to a second embodiment of the invention,

FIG. 3 schematically shows an enlarged top view of the attachment and stresses applied on the attachment according to the first embodiment of the invention,

FIG. 4 schematically shows a top view of a balance-spring according to a third embodiment of the invention, and

FIG. 5 schematically shows a top view of an elongated flexible element according to the second and the third embodiment of the invention.

### DETAILED DESCRIPTION OF THE INVENTION

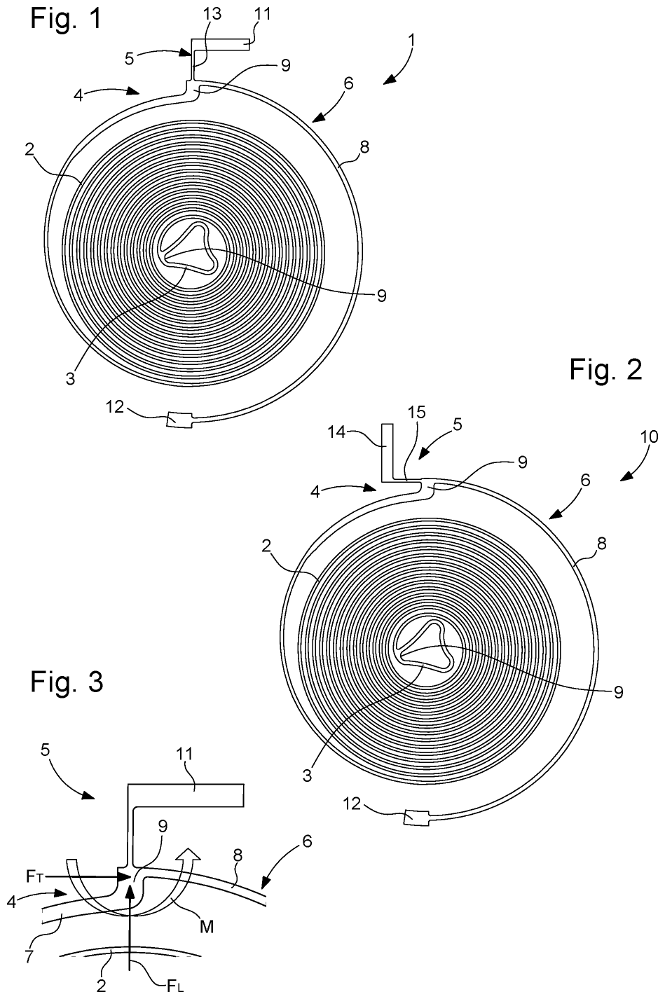

FIGS. 1 and 2 each show a schematic representation of a different embodiment of a balance-spring 1, 10, 20, particularly for a timepiece resonator mechanism. Here, the balance-spring extends substantially in the same plane. The balance-spring 1, 10, 20 comprises a flexible strip 2 coiled around itself according to a plurality of coils, the strip 2 having a predefined stiffness. The balance-spring 1, 10, 20 includes means for adjusting 5 its stiffness. For example, the adjustment means can be particularly actuated when the balance-spring 1, 10, 20 is mounted on a plate of a horological movement, not shown in the figures.

According to the invention, the adjustment means include a flexible element 5 extending longitudinally, which is arranged in series of the strip 2, the flexible element 5 connecting one end 4 of said strip 2 to a fixed support 11, 14. In other words, the strip 2 is connected to the fixed support 11, 14 only by this flexible element 5.

The flexible element 5 is integral with one of the ends 4 of the strip 2. The embodiments described below comprise a flexible element 5 integral with the outer end 4 of the strip 2. The inner end 9 of the strip 2 is intended to be assembled to a support 3 of an oscillating mass of the resonator 1.

The flexible element 5 adds an additional stiffness to that of the strip 2. The flexible element 5 preferably has a stiffness greater than that of the strip 2. The flexible element 5 here is arranged in the extension of the strip 2. Preferably, the adjustment means 5 and the strip 2 are one-piece, or even made of the same material.

Furthermore, the end of the strip 2 here is curved perpendicularly to form an attachment 9, preferably substantially stiff, that is to say at least stiffer than the strip 2 and/or the elongated flexible element 5

Preferably, the longitudinal flexible element 5 is a single flexible blade 13, 15 connecting the attachment 9 to the fixed support 11, 14.

In the first embodiment, the single flexible blade 13 is arranged in the extension of the attachment 9. The single flexible blade 13 is disposed in a direction perpendicular to the strip 2.

Thus, the single flexible blade 13 is arranged in a radial direction, preferably passing through the centre of the balance-spring 1, in locking position of the balance-spring 1.

The balance-spring 1 further includes prestressing means 6 to apply on the flexible element 5 at least two different stresses, a longitudinal F_{L} tensile-compressive force, and an orthogonal force F_{T}, which are variable. The longitudinal force F_{L} is directed in the longitudinal direction of the flexible element 5, whereas the orthogonal force F_{T}, is directed in a direction perpendicular to the longitudinal direction of the flexible element 5, the two forces preferably belonging to the plane of the balance-spring 1, 10, 20. The prestressing means 6 are further configured to apply on the flexible element 5 a torque M, preferably a bending moment.

Thus, it is possible to adjust the stiffness of the balance-spring 1, 10, 20, particularly to improve the precision of the rate of the movement.

The prestressing means 6 make it possible, preferably, for the flexible element 5 to undergo a compressive or tensile force according to the value of the forces. Thus, the stiffness of the flexible element 5 is varied.

The flexible element 5 only is acted on to modify its stiffness without directly acting on the strip 2. Thus even greater precision is obtained because only one element is used to adjust the stiffness. During the oscillations, the end 4 of the strip 2 may be mobile.

In addition, the longitudinal F_{L} and orthogonal F_{T} forces can be continuously adjusted by the prestressing means 6. In other words, the F_{L} and F_{T} forces are not restricted to discrete values. Thus, it is possible to adjust the stiffness of the flexible element 5 with a high precision.

In this embodiment, the prestressing means 6 include a lever 8 joined to the outer end 4 of the strip 2. The lever 8 is curved and surrounds a portion of the coiled strip 2. The lever 8 has a semi-circular, or arc-of-circle shape of angle at the centre close to 180°, joined to the attachment 9 of the end 4 of the strip 2. The lever 8 further comprises a free end 12 that can be actuated by a movement of said free end 12, in order to apply said stresses. The lever 8 is preferably flexible. The lever 8 is preferably arranged in the plane of the balance-spring 1.

Such a lever 8 makes it possible to keep a balance-spring 1 with a small size, the dimensions being restricted to be able to be inserted into a horological movement. Indeed, the prestressing means 6 have a shape that is compatible with the strip 2, in such a way as to keep sufficiently small dimensions, because each portion of the prestressing means 6 is close to the strip 2. The width of the balance-spring 1 is modified little by the prestressing means. Thus, the balance-spring 1 is sufficiently compact to be able to be inserted easily into a movement.

The lever 8 and the longitudinal flexible element 5 are joined to the attachment 9 of the curved portion of the end 4.

As shown in FIG. 3, the actuation of the lever 8 produces on the end 4 of the strip 2 the longitudinal force F_{L} directed along the longitudinal axis of the longitudinal flexible element 5, as well as an orthogonal force F_{T} directed in an orthogonal direction. The actuation of the lever 8 further produces a torque or a bending moment M on the single blade 5, shown by a curved arrow.

Thus, the prestressing means 6 are configured to exert a force directed substantially in the longitudinal direction of the elongated flexible element 5. The prestressing means 6 are also configured to exert a force directed substantially in a direction orthogonal to the longitudinal direction of the blade. The prestressing means 6 are also configured to exert a torque M, preferably a moment of force on the single flexible blade 13. Thus, the stiffness of the single blade 13, and therefore of the assembly comprising the strip 2 and the single flexible blade 13 is modified.

The longitudinal F_{L} and orthogonal F_{T} forces and the torque M are varied by the movement of the free end 12 of the lever 8. The free end 12 is preferably stiff to facilitate its actuation. Thus, the stiffness of the flexible element 5 and therefore of the assembly comprising the flexible element 5 and the strip 2 is varied.

In the second embodiment of the FIG. 2, the longitudinal flexible element 5 comprises a single flexible blade 15 arranged in the extension of the lever 8, tangentially to the strip 2 coiled in locking position of the balance-spring 1. Thus, the single flexible blade 15 is substantially perpendicular to the single flexible blade 13 of the first embodiment. The single flexible blade 15 joins the attachment 9 to a fixed support 14, which is arranged perpendicular to the fixed support of the first embodiment.

The other features of this embodiment are substantially the same as those of the first embodiment. The longitudinal F_{L} and orthogonal F_{T} forces are oriented in a direction perpendicular to that of the first embodiment. However, the effect produced by these forces and the torque M is the same as regards the variation of the stiffness of the flexible element.

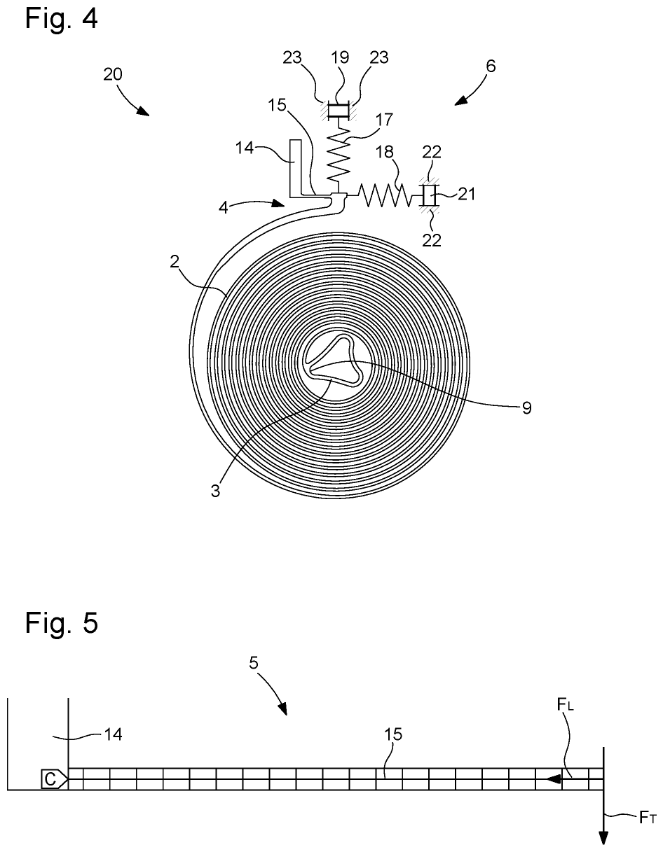

In the embodiment of FIG. 4, the features are the same as those of the second embodiment of FIG. 2, except for the prestressing means 6. The lever is replaced with two means for applying a force each comprising a spring 17, 18 and a rigid body 19, 21, the two means for applying a force being arranged perpendicular to one another. The two springs 17, 18 are joined to the attachment 9 on the one hand, and to the rigid body 19, 21 on the other hand. A means for applying a force is directed along the longitudinal axis of the single flexible blade 15, which is tangential to the coiled strip 2. The second means for applying a force is directed along an axis substantially perpendicular to the single flexible blade 15. The rigid bodies 19, 21 are preferably guided between fixed supports 22, 23.

By moving the rigid bodies 19, 21, a variable longitudinal force F_{L} and a variable orthogonal force F_{T} is applied on the attachment 9, in each direction of movement of each rigid body 19, 21. Thus, the stiffness of the single flexible blade 15 is modified in a similar way to the second embodiment. By moving the rigid body 19, 21, the value of the force exerted on the single flexible blade 15 is modified.

In the figures, the springs 17, 18 are conventional springs, but they may be replaced with an arrangement of substantially parallel flexible blades, which act as springs.

FIG. 5 shows the single flexible blade 15, such as that of the second and third embodiments, which is actuated by the prestressing means, and for which a longitudinal force and an orthogonal force is obtained. The longitudinal force is directed in the longitudinal direction of the single flexible blade 15, whereas the orthogonal force is substantially perpendicular to this longitudinal direction. The two forces are applied at the end of the single flexible blade 15 and of the attachment 9.

In this embodiment, the prestressing means 6 do not exert torque or bending moment on the end 4 of the strip 2, but only the longitudinal F_{L} and orthogonal F_{T} forces.

The invention also relates to a horological movement comprising such a balance-spring. The balance-spring is particularly used to actuate the movement of a balance.

Naturally, the invention is not limited to the embodiments described with reference to the figures and variants may be envisaged without departing from the scope of the invention.

As regards the longitudinal element, the flexible blades described in the various embodiments of the balance-spring, may be continuous flexible blades, as this is generally the case in the figures, or blades with rigid sections and flexible necks connecting the sections.

Furthermore, the single flexible blade may take orientations other than radial and orthogonal in relation to the balance-spring. Thus, it may be oriented in any direction between the radial and orthogonal directions.

1. A balance-spring, particularly for timepiece resonator mechanism, the balance-spring (1, 10, 20) comprising:
a flexible strip (2) coiled around itself according to a plurality of coils, the strip (2) having a predefined stiffness; and
means for adjusting its stiffness,
wherein the adjustment means include a single elongated flexible element (5) arranged in series of the strip (2), the elongated flexible element (5) connecting one end (4, 9) of said strip (2) to a fixed support (11, 14), in such a way as to add an additional stiffness to the strip (2), the elongated flexible element (5) having a stiffness greater than that of the strip (2),
the adjustment means including prestressing means (6) to apply at least two different stresses on the elongated flexible element (5), the first stress being provided by a tensile/compressive force directed substantially in the longitudinal direction F_{L} of the elongated flexible element (5), and the second stress being provided either by a force directed substantially in a direction substantially orthogonal F_{T} to the longitudinal direction of the elongated flexible element (5), or by a torque M, preferably a bending moment, in such a way as to vary the stiffness of the elongated flexible element (5) depending on the prestressing level.

2. The balance-spring according to claim 1, wherein the prestressing means (6) are configured to exert a third stress on the elongated flexible element (5), the third stress being provided, respectively to the second stress, or by a force directed substantially in a direction substantially orthogonal F_{T} to the longitudinal direction of the elongated flexible element (5), or by a torque M, preferably a bending moment.

3. The balance-spring according to claim 1, wherein the longitudinal flexible element (5) is a single flexible blade (13).

4. The balance-spring according to claim 1, wherein the flexible element (5) is arranged in a radial direction of the balance-spring (1).

5. The balance-spring according to claim 1, wherein the flexible element (5) is arranged in a direction tangential to the balance-spring (10, 20).

6. The balance-spring according to claim 1, wherein the prestressing means (6) include a lever (8) joined to the end (4, 9) of the strip (2).

7. The balance-spring according to claim 1, wherein the lever (8) is flexible.

8. The balance-spring according to claim 1, wherein the lever (8) is curved and surrounds at least partially the coiled strip (2).

9. The balance-spring according to claim 6, wherein the lever (8) comprises a free end (12) that can be actuated by a movement of said free end (12) in order to apply said stresses on the end (4).

10. The balance-spring according to claim 1, wherein the prestressing means (6) include two means for applying a force, each means for applying a force being provided with a spring (17, 18) connected to the end (4) to apply said longitudinal force F_{L} or said orthogonal force F_{T} on the end (4).

11. The balance-spring according to claim 1, wherein the end (4, 9) of the strip (2) comprises an attachment (9), the prestressing means (6) and the elongated flexible element (5) being joined to the attachment (9).

12. The balance-spring according to claim 1, wherein the stresses can be continuously adjusted by the prestressing means (6).

13. The balance-spring according to claim 1, wherein the flexible element (5) is arranged at one outer end (4) of the strip (2).

14. The balance-spring according to claim 1, wherein the end (4, 9) of the strip (2) is stiffer than the elongated flexible element (5) and the strip (2).

15. A rotary resonator mechanism, particularly for a horological movement, including an oscillating mass, wherein it comprises a balance-spring (1, 10, 20) according to claim 1.
